(19) United States
(12) Patent Application Publication
(10) Pub. No.: US 2007/0143258 A1
(43) Pub. Date: Jun. 21, 2007

(54) Method and system for generating a collaborative search chronicle in a network environment

(76) Inventors: Ori Pomerantz, Austin, TX (US); Andrew R. Jones, Round Rock, TX (US); Gregory J. Boss, American Fork, UT (US); Kevin C. McConnell, Austin, TX (US); Timothy M. Waters, Hiram, GA (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/304,946

(22) Filed: Dec. 15, 2005

(51) Int. Cl. G06F 17/30

(52) U.S. Cl. 707/3

(57) ABSTRACT

A method, system and program of generating a chronicle of search terms used in a network environment of a community are provided. A term is received from a user in a current search. The term is matched in a search chronicle, wherein the search chronicle is a database comprising a plurality of search terms associated with a search originator. The search chronicle results are then provided to the user.

### FIELD OF THE INVENTION

The present invention relates to data processing systems and to the processes of searching for information in a network environment. In particular, the present invention provides a method, program and system for generating a collaborative search chronicle based on histories of searched terms and user identifications within a network environment.

### BACKGROUND OF THE INVENTION

Data processing systems, such as computers, have made searching for information a routine task. For example, today a user is able to routinely search for information on myriad topics by entering a search term or keyword(s) in a manner well known in the art. A typical search engine matches these search terms or keywords through databases of information or through a plurality of documents stored on a network, such as a local intranet or the Internet.

Modern database management systems provide an individual user with the matched terms in a manner well known in the art, generally as a list of matches and often as an interactive list so that more information can then be determined about the matches by clicking on or otherwise selecting a match.

Meanwhile, modern browsers allow an individual user to navigate easily through stored documents that have been searched (also known as “web sites” on the Internet). Most browsers provide a device that enables an individual user to navigate through the documents that (s)he has previously visited. This “history” generally lasts through the time that an individual user starts the browser program until the browser program is terminated (this time period is often called a “session”).

However, in any organization, more than one user may be searching for the same search terms or keywords. Currently, the only way these users would be aware of each other's existence (and each other's search queries) is by directly alerting each other about the searches each one is conducting. While there are many methods for an individual user to document his/her search information for use by other users, all of them require extra effort. Users may not have the time and energy to devote such extra effort to the documentation of spoken knowledge and content. Barring a deposition-style querying of individuals users about what searches they have recently done or an organization-wide policy of having employees take notes on their individual searches, organizations have no means of chronicling a consistent history of all the searches being performed within the organization's network. Furthermore, individual users may not have the information resources to collaborate the identity of users with their search terms and additional information (such as the user's position/title in the organization or the dates and times that the searches occurred).

The present invention advances the art.

### SUMMARY OF THE INVENTION

The method of the present invention generates a chronicle of search terms used in a network environment of a community. A term is received from a user in a current search. The term is matched against a search chronicle database comprising a plurality of search terms, each search term associated with a search originator. The search results from the search chronicle are provided to the user.

The method further matches the term against a knowledge base in communication with the network environment and providing the knowledge base search results to the user. The method determines if the user has chosen not to add the current search to the search chronicle. If the user has not chosen to add the search, the current search is suppressed from the search chronicle. Otherwise, the current search is added to the search chronicle.

The method further determines if the user is authorized to access details about the search originator(s) and displays the search originator details based on the determined authorization.

The method further matches the term against a plurality of available collaborative documents and displays at least one matching collaborative document. The method further provides for creating a collaborative document in association with at least one search term.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram of a user interface in accordance with one embodiment of the present invention;

FIG. 2 is a block diagram of a network of data processing systems in which the present invention may be implemented;

FIG. 3 is a block diagram of a data processing system that may be implemented as a server in accordance with a preferred embodiment of the present invention;

FIG. 4 illustrates a method of generating a search chronicle in accordance with one embodiment of the present invention;

FIG. 5 illustrates a method of generating a collaborative search chronicle in accordance with another embodiment of the present invention; and

FIG. 6 is a flow diagram of a method for generating a chronicle of search terms used in a given community, in accordance with the present invention.

### DETAILED DESCRIPTION OF THE PRESENTLY PREFERRED EMBODIMENTS

The present invention implements a data processing system and method for generating a collaborative search chronicle in a network environment. In the following description, numerous specific details are set forth to provide a thorough understanding of the present invention. However, it will be obvious to those skilled in the art that the present invention may be practiced without such specific details. In other instances, well-known devices have been shown in block diagram form in order not to obscure the present invention in unnecessary detail.

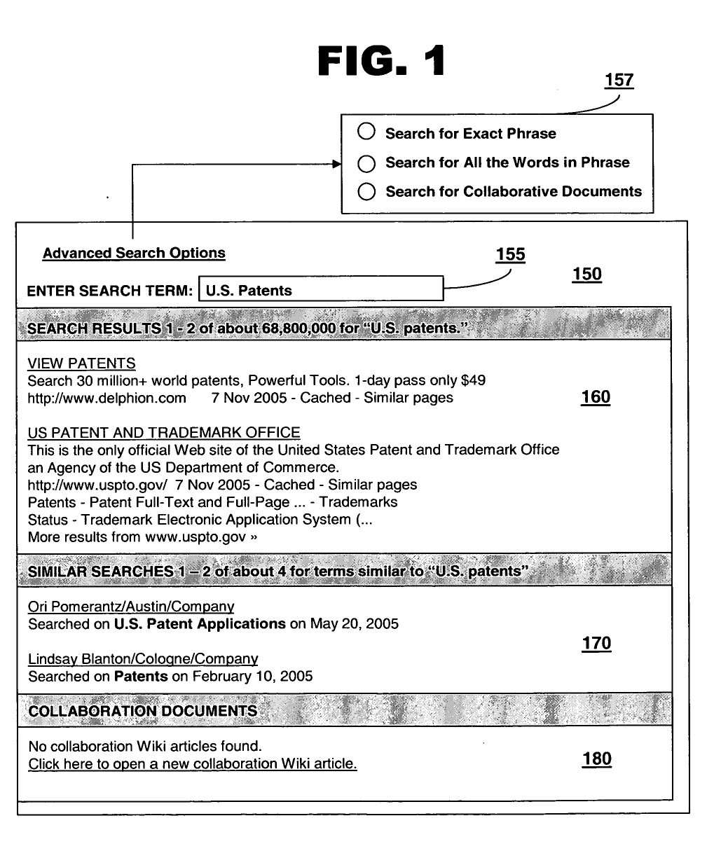

FIG. 1 is a pictorial representation of one embodiment of a user interface generated in accordance with the present invention. User interface 150 comprises a data entry area 155, a user preferences area 157 as well as three result areas—knowledge base results 160, search chronicle results 170 and collaboration document results 180. In one embodiment of the invention, one or more result areas are presented to a user in interface 150. Interface 150 takes the form of a web page with interactive text or of any other user-accessible and/or user-editable document.

Data entry area 155 is any suitable area for the user to enter a desired search term for searching in accordance with the present invention.

This term may comprise a user-defined search expression, also called a “search term” or “keyword”. Typically, the term is a user-defined search string. The string may be a nonregular expression or may include a wildcard pattern as is known in the art. The user may enter the term as an open string as seen in FIG. 1. In other embodiments, the user may select the string from a given list. The list may comprise, for example, a series of previously searched strings or a series of often-searched strings. The list may take the form of, for example, a drop-down menu.

User preference area 157 allows the user to configure preferences regarding the search term. For example, the user may designate whether the term should be searched “exactly as is”. The user may also designate that part of the string is a wildcard component. The user may also designate at this time whether (s)he wants the search to include searches of collaborative documents. The user may designate any other preferences such as language of search, specific location (s)he desires to search (printed books, newspapers, a particular organization's white pages, etc.)

Knowledge base results 160 comprise, for example, the results from a search based on a particular term. Search methods in a network environment are well-known in the art. A typical search method starts with a user-defined search expression, also called a ‘search term’ or ‘keyword’ that is typically a user-defined search string. The method matches the user-defined search expression against a data structure or a knowledge base. Some known knowledge bases are databases, radix trees, dictionaries and stored documents. The search method searches through all the strings in the knowledge base. Matches of the user-defined search expression to the string in the knowledge base are considered “search results” and may be displayed to the user, for example, as seen in results area 160.

Search chronicle results 170 comprise, for example, the results from a search of a particular database, namely a search chronicle database. The search chronicle database may resemble, for example, the table shown in Table 1 below:

TABLE 1
Search Chronicle

| | | | SEARCH |
|---|---|---|---|
| ID NUMBER | USER NAME | SEARCH TERM | DATE |
| AUS2000 | Ori Pomerantz | Patent Prosecution | May 20, 2005 |
| AUS1890 | David Freeman | Patent Applications | May 19, 2005 |
| DUS1999 | Lindsay Blanton | U.S. Patents | Feb. 10, 2005 |
| AUS1321 | Aslam Tejani | Patents | May 10, 2005 |
| AUS1321 | Aslam Tejani | U.S. Patents | Apr. 10, 2005 |
| AUS1890 | David Freeman | Trademarks | May 19, 2005 |

Typical search methods as are known in the art may be used to match the user-defined search expression against the search chronicle database. Matches of the user-defined search expression to any strings in the search chronicle database are considered “search chronicle results” and may be displayed to the user, for example, as seen in results area 170.

Thus, if the example of Table 1 is a search chronicle database, a search for the keyword “patent” would generate search chronicle results 170 that listed the first five items in Table 1 but would not include the last item in Table 1.

Collaborative document results 180 comprise, for example, the results from a search of existing collaborative documents available to a user. The collaborative documents may be, for example, documents that provide an environment using only a web browser to create collectively authored and collectively connected hypertext documents using a simple structured text markup language. In one embodiment of the invention, the collaborative documents are WIKI documents, created according to the WIKI protocol as is well known in the art and as is further described at What Is Wiki? web site (http://wiki.org/wiki.cqi?WhatIsWiki)

Typical search methods as are known in the art may be used to match the user-defined search expression against existing collaborative documents. These documents may be stored in one place (for example on a designated server as described further below). Alternatively, the documents may be available on the Internet or a local intranet. Matches of the user-defined search expression to any strings in the available collaborative documents are considered “collaborative document results” and may be displayed to the user, for example, as seen in results area 180.

Thus, using Example 1 below, a search for keyword “patent” through List 1's available collaborative documents would generate collaborative document results 180 that listed the first and third items in Example 1 but would not include the second item in Example 1.

### EXAMPLE 1

### Available Collaborative Documents

WikiPatent—Collaboratively Created Encyclopedia of Patents http://en.wikipatent.org/wiki/Main Page
WikiTrademark—Collaborative Trademark Resource http://en.wikitm.org/wiki/Main Paqe
WikInvent—Collaboratively Created List of Wild Patent Inventions http://en.wikinvent.org/wiki/Main Page

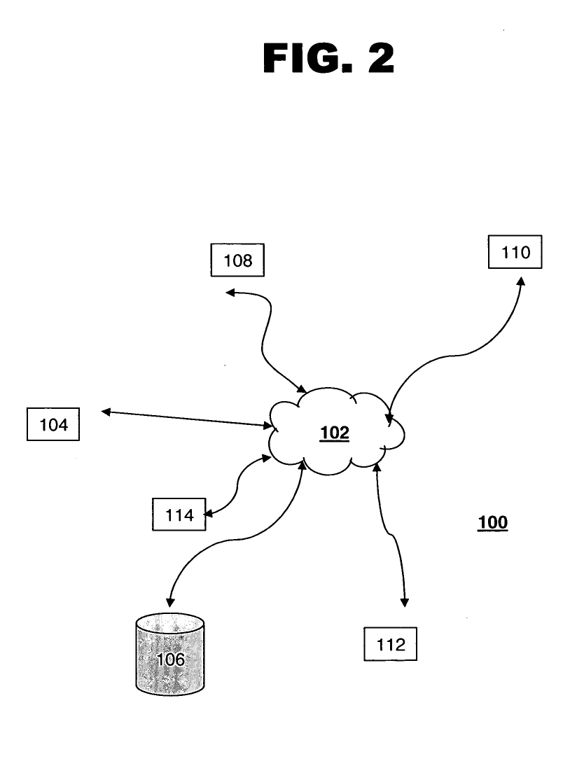

FIG. 2 is a pictorial representation of one embodiment of a distributed data processing system in which the present invention is implemented. Distributed data processing system 100 comprises a network 102, which is the medium used to provide communications links between various devices and computers connected together within distributed data processing system 100. Network 102 may include permanent connections, such as wire or fiber optic cables, or temporary connections made through telephone connections. The various processes that comprise the present invention may reside on the same host machine or on different machines interconnected over network 102. (e.g., the Internet, an intranet, a wide area network (WAN) or local area network (LAN)). Thus, machines benefiting from the present invention have appropriate networking hardware to establish a connection to one or more other machines (server and/or client computer). For example, machines connected to network 102 may have a TCP/IP or NETBIOS connection to a network running over a token ring or Ethernet adapter.

A server 104 is connected to network 102 as described above, along with storage unit 106. Server 104 provides data, such as core executables and supporting files to run interpreted programming language applications to client computers 108, 110, 112. Such data may be stored on storage unit 106 and accessed by server 104.

Search engine 114 may serve to coordinate the searching of knowledge bases, search chronicles and available collaborative documents in accordance with the present invention. Search engine 114 may be in connection with server 104 or may be located on server 104.

Search engine 114 may employ one or more search methods as are known in the art. A user-defined search expression may be received at search engine 114 from anywhere in network 102. Typically, server 104 or client computers 108, 110, 112 will provide the search expression to search engine 114. Search engine 114 matches the user-defined search expression against a data structure or a knowledge base. Some known knowledge bases are databases, radix trees and dictionaries. One or more of the knowledge bases, search chronicle databases and available collaborative documents may be stored on storage unit 106 and searched with search engine 114. Alternatively, search engine 114 may be capable of searching any knowledge bases, search chronicle databases or collaborative documents anywhere within network 102. Search engine 114 may search through all the strings in the knowledge base, search chronicle database or collaborative document in accordance with the present invention.

In an illustrative embodiment of the present invention, the search engine 114.

Client computers 108, 110, and 112 are also connected to network 102. Client computers 108, 110, and 112 may be, for example, personal computers or network computers, having a variety of processors and operating systems.

Distributed data processing system 100 may include additional servers, clients, and other devices not shown. FIG. 1 is intended as an example, and not as an architectural limitation for the processes of the present invention.

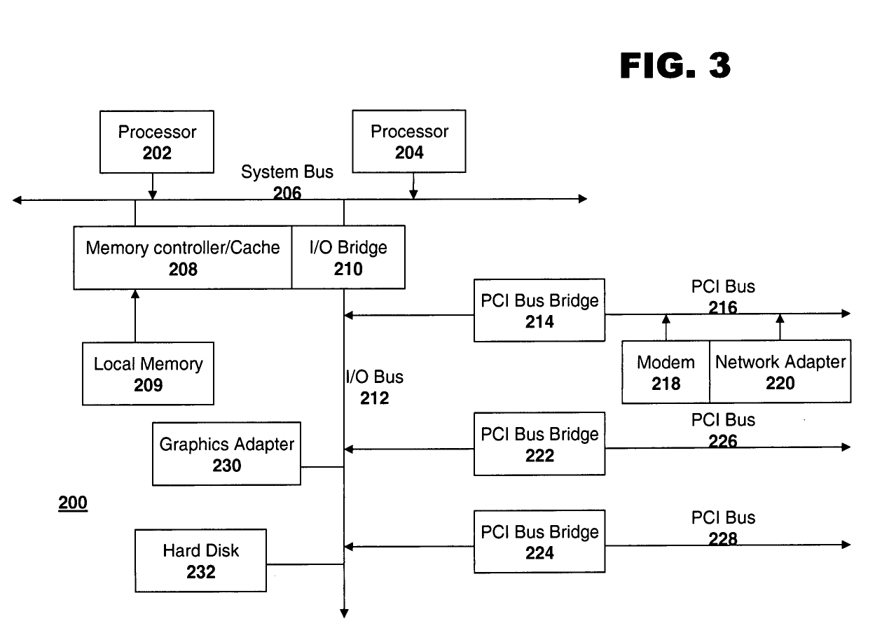

FIG. 3 is a block diagram of a data processing system that may be implemented as a server, such as server 104 in FIG. 1. In one embodiment of the invention, a search engine 114 may be executed on data processing system 200. Furthermore, search chronicles and/or collaborative documents generated in accordance with the present invention may be stored on data processing system 200 as is well known in the art.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The data processing system depicted in FIG. 3 may be, for example, an IBM eServer pSeries, a product of International Business Machines Corporation in Armonk, N.Y., running the Advanced Interactive Executive (AIX) operating system. FIG. 3 is not meant to imply architectural limitations with respect to the present invention.

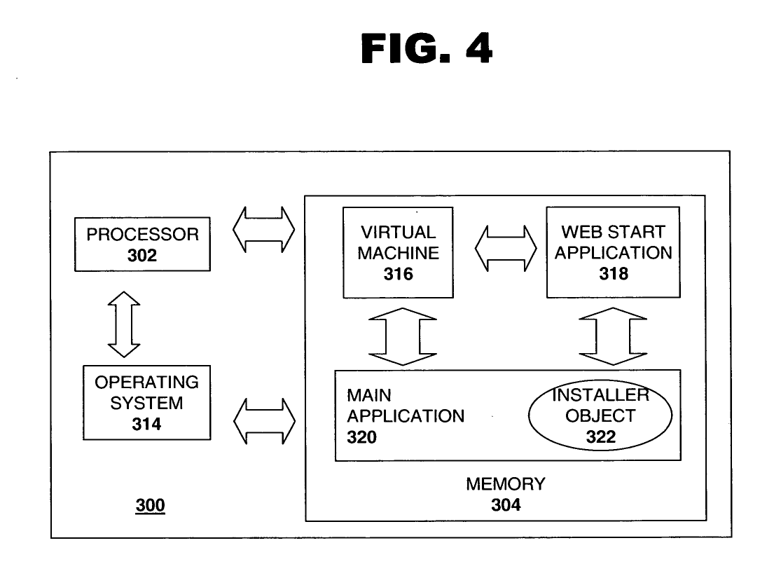

FIG. 4 is a block diagram of a data processing system that may be implemented as a client computer, such as computers 108, 110, 112. One or more of the processes that input or receive search terms or initiate searches or provide search results may be carried out on such a client computer, or on one more such computers connected via a computer network. For example, the user interface 150 may be available on client computers 108, 110, 112.

In addition to other components, the data processing system 300 of FIG. 3 comprises processor 302, main memory 304, operating system 314, and at least two virtual machine interpreters 316, 326. One VM 316 is used to run a web start application 318 having a bootstrap class 319. Another VM 318 is used to run one or more main application program 328.

Operating system 314 runs on processor 302 and is used to coordinate and provide control of various components within data processing system 300 in FIG. 4. The operating system may be a commercially available operating system, such as Windows XP, which is available from Microsoft Corporation. One or more programming systems may run in conjunction with the operation system 314, including but not limited to Java, BASIC and the like. (“Java” is a trademark of Sun Microsystems, Inc.). Means for running the operating system, programming systems and applications or programs are located on storage devices, such as hard disk drives and may be loaded into main memory 304 for execution by processor 302.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may also be used in addition to, or in place of, the hardware depicted in FIG. 4. Also, the processes of the present invention may be applied to a multiprocessor data processing system.

Thus, for example, client computer 108, 110, 112 is any personal computer or workstation platform that is Intel-, PowerPC- or RISC-based, and that includes an operating system such as IBM OS/2, Microsoft Windows XP, Microsoft Windows NT 4.0, Unix, AIX 5SL or the like. A representative computer runs an Intel x86 processor, the OS/2 Warp Version 3 operating system, JVM Version 1.1.1 and Java Web Start 1.04. Alternatively, the computer runs an x86 processor, the Windows XP (or Windows NT) operating system, JVM version is 1.4 and above.

FIG. 4 is not meant to imply architectural limitations. For example, data processing system 300 also may be a notebook computer, hand held computer or Personal Digital Assistant. Data processing system 300 also may be a kiosk or a Web appliance.

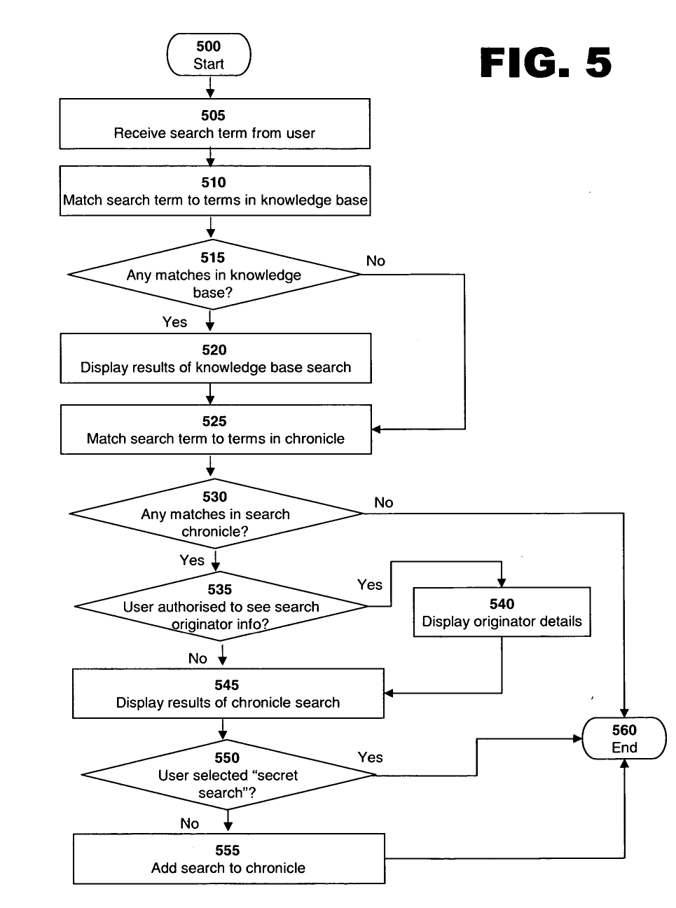

FIG. 5 is a flow diagram of one method 500 of generating a chronicle of search terms used in a given community, in accordance with the present invention. The method of the present invention can be accomplished by a computer program product accessible from a computer-usable or computer-readable medium providing program code for use by or in connection with a computer or any instruction execution system. Although the steps described in method 500 are shown in a given order, the steps are not limited to the order illustrated. Moreover, not every step is necessarily required to accomplish the method of the present invention.

As seen at block 505, a search term is received from the user by the search engine. This term may comprise a user-defined search expression, also called a “search term” or “keyword”. Typically, the term is a user-defined search string. The string may be a nonregular expression or may include a wildcard pattern as is known in the art. The user may enter the term as an open string or may select the string from a given list. The list may comprise, for example, a series of previously searched strings or a series of often-searched strings. The list may take the form of, for example, a drop-down menu on user interface 150.

In one embodiment of the invention, the user also configures preferences regarding the search term. For example, the user may designate whether the term should be searched “exactly as is”. The user may also designate that part of the string is a wildcard component. The user may also designate at this time whether (s)he wants the search to include searches of collaborative documents. Other configurable preferences are also considered in the scope of this invention, such as the preferred language and/or scope of the search. These preferences may be configured from, for example, a dialogue box 157 on user interface 150.

As seen at block 510, the search term is matched to terms (strings) in a knowledge base. A knowledge base may be any suitable database, radix tree or dictionary. A knowledge base may also comprise the Internet or a local intranet.

As seen at block 515, it is determined if there are any matches to the search term to be found in the knowledge base. If there are no matches in the knowledge base, the method proceeds directly to block 525.

If there are matches, the method first proceeds to block 520 before continuing to block 525. At block 520, the matches are displayed as search results. For example, the matches may be displayed in the format of search results area 160.

As seen at block 525, the search term is matched to terms (strings) in a search chronicle. As seen in Table 2, the search chronicle provides a history of previous search terms associated with a given user's online identification. In the illustrative example of Table 1, this is called an ‘identification number’ but any suitable identification is possible. In addition, the search chronicle may also provide the date and/or time that a search was performed, the name of the search originator performing a given search and other information about the search originator such as, for example, job title, geographic location in the organization, status in the organization, how often this person has searched the same term, etc.

TABLE 2
Search Chronicle

| | | SEARCH | USER | USER |
|---|---|---|---|---|
| ID | SEARCH TERM | DATE | NAME | LOCATION |
| AUS2000 | Patent | May 20, 2005 | Pomerantz | Austin |
| | Prosecution | | | |
| AUS2000 | Patent | Jun. 20, 2005 | Pomerantz | Austin |
| | Prosecution | | | |
| AUS1890 | Patents | May 19, 2005 | Freeman | Austin |
| DUS1999 | U.S. Patents | Feb. 10, 2005 | Blanton | Dusseldorf |
| AUS1321 | Patents | May 10, 2005 | Tejani | Austin |
| AUS1321 | U.S. Patents | Apr. 10, 2005 | Tejani | Austin |
| AUS1890 | Trademarks | May 19, 2005 | Freeman | Austin |

As seen at block 530, it is determined if there are any matches to the search term to be found in search chronicle. If there are no matches in the knowledge base, the method proceeds directly to block 560 and ends. If there are matches, the method proceeds to block 535 before continuing to block 545.

As discussed above, the search chronicle may include more information than a user ID indicating a search originator and associated with a search term. Thus, at block 535, it is determined whether the user is authorized to see this additional information about other search originators. If the user is not authorized, a “sanitized” version of the search chronicle will be displayed at block 545 for the user as seen in Example 2 below. The matches are displayed as search chronicle results. For example, the matches may be displayed in the format of search chronicle results area 170.

### EXAMPLE 2

### Search Chronicle Results, Sanitized

Search term: Patents, Displaying results 1-6 of 210

The term “Patents” was searched by AUS1890 on May 19, 2005
The term “Patents” was searched by AUS1321 on May 10, 2005
The term “Patent Law” was searched by AUS2000 on May 20, 2005
The term “Patent Law” was searched by AUS2000 on Jun. 20, 2005
The term “U.S. Patents” was searched by DUS1999 on Feb. 10, 2005
The term “U.S. Patents” was searched by AUS1321 on Apr. 10, 2005

As seen at block 540, if the user is authorized, the originator details will be displayed. Thus, at block 545 the results displayed to the user will resemble Example 3 below. The matches are displayed as search chronicle results. For example, the matches may be displayed in the format of search chronicle results area 170.

### EXAMPLE 3

### Search Chronicle Results

Search term: Patents, Displaying results 1-8 of 210

David Freeman, Austin searched on “Patents” May 19, 2005
Lindsay Blanton, Dusseldorf searched on “Patents” May 10, 2005
Ori Pomerantz, Austin searched on “Patent Law” Jun. 20, 2005
Ori Pomerantz, Austin searched on “Patent Law” May 20, 2005
David Freeman, Austin searched on “Patent Law” Apr. 20, 2005
Aslam Tejani, Austin searched on “Patent Law” May 20, 2005
David Freeman, Austin searched on “U.S. Patents” Apr. 10, 2005
Aslam Tejani, Austin searched on “U.S. Patents” Feb. 10, 2005

The chronicle search results may display the closest match first as seen in Example 3 where David Freeman and Lindsay Blanton's searches match the exact user search term “patents”.

Alternatively, the search chronicle may be weighted so that certain searches are displayed first. That is, a given search may be weighted based on the date/time that the search was performed (e.g. older searches get less weight) as seen in Example 4.

### EXAMPLE 4

### Search Chronicle Results

Search term: Patents, Displaying results 1-8 of 210

Ori Pomerantz, Austin searched on “Patent Law” Jun. 20, 2005
Ori Pomerantz, Austin searched on “Patent Law” May 20, 2005
Aslam Tejani, Austin searched on “Patent Law” May 20, 2005
David Freeman, Austin searched on “Patents” May 19, 2005
Lindsay Blanton, Dusseldorf searched on “Patents” May 10, 2005
David Freeman, Austin searched on “Patent Law” Apr. 20, 2005
David Freeman, Austin searched on “U.S. Patents” Apr. 10, 2005
Aslam Tejani, Austin searched on “U.S. Patents” Feb. 10, 2005

Alternatively, a set of searches may be weighted if a search term is used frequently (e.g. if a search term is used frequently, the chronicle search results may show that term) as seen in Example 5 with the term “patent law”

### EXAMPLE 5

### Search Chronicle Results

Search term: Patents, Displaying results 1-8 of 210

Ori Pomerantz, Austin searched on “Patent Law” Jun. 20, 2005
Ori Pomerantz, Austin searched on “Patent Law” May 20, 2005
Aslam Tejani, Austin searched on “Patent Law” May 20, 2005
David Freeman, Austin searched on “Patent Law” Apr. 20, 2005
David Freeman, Austin searched on “Patents” May 19, 2005
Lindsay Blanton, Dusseldorf searched on “Patents” May 10, 2005
David Freeman, Austin searched on “U.S. Patents” Apr. 10, 2005
Aslam Tejani, Austin searched on “U.S. Patents” Feb. 10, 2005

The searches may also be weighted for display based on any suitable hierarchy such as the user location. In one embodiment, the user may configure preferences for the display of search results, designating for example, that results from a particular time period be shown or that results from a particular set of users be shown. These user preferences may be set using any suitable means of configuring a search engine as is well known in the art. In one embodiment the user preferences are set in user preference 157.

As seen at block 550, it is determined whether the user conducting the extant search has selected a “secret search” option. This “secret search” option allows the user to conduct a search without having the search added to the search chronicle. If the user has selected the “secret search” option, the method proceeds to block 560 and ends. If the user has not selected the “secret search” option, the method adds the user's current search to the search chronicle. The current search will now be part of the chronicle of search terms used within the user's community. If another user searches a similar term, the current search may show up within the search chronicle results 170.

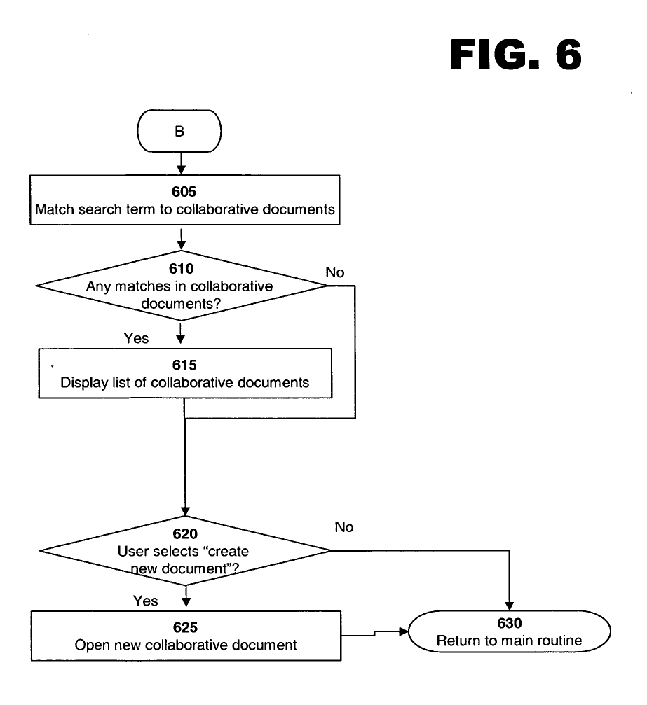

FIG. 6 is a flow diagram of one subroutine 600 of a method of generating a chronicle of search terms used in a given community, in accordance with the present invention. The subroutine of the present invention can be accomplished by a computer program product accessible from a computer-usable or computer-readable medium providing program code for use by or in connection with a computer. Although the steps described in subroutine 600 are shown in a given order, the steps are not limited to the order illustrated. Moreover, not every step is necessarily required to accomplish the method of the present invention.

Furthermore, subroutine 600 may be invoked at any suitable moment of routine 500, such as, for example, before it is determined if the user is authorized to see search originator information, before the chronicle search results as displayed, before it is determined if the user has selected a “secret search” option, etc.

As seen at block 605 it is determined if there are any matches to the search term to be found in one or more available collaborative documents. If there are no matches in any available collaborative documents, the method proceeds directly to block 620.

If there are matches, the method proceeds to block 615 wherein a list of one or more collaborative documents is displayed to the user. The matches are displayed as collaborative document results. For example, the matches may be displayed in the format of collaborative document results area 180.

The collaborative documents may be, for example, documents that provide an environment using only a web browser to create collectively authored and collectively connected hypertext documents using a simple structured text markup language. In one embodiment of the invention, the collaborative documents are WIKI documents, created according to the WIKI protocol as is well known in the art. In an illustrative embodiment, only one collaborative document will typically be found and made available to the user.

As seen at block 620, if there are no available collaborative documents, the user may elect to create a new collaborative document. The user may indicate this choice by several interactive means well known in the art, such as for example, clicking on an active hyperlink in user interface 150. If the user does not choose to create the new document, the subroutine returns at block 630 to the main routine 500.

If the user chooses to create a new collaborative document, the document is created at block 625. The newly created document may be for example, a hyptertext document that is collectively connected and uses a simple structured text markup language. In one embodiment of the invention, the new collaborative document is a WIKI document, created according to the WIKI protocol as is well known in the art. After the new document is made available to the user, the subroutine returns at block 630 to the main routine 500. The newly created collaborative document will now be part of the available collaborative documents used within the user's community. If another user searches a similar term, the collaborative document may show up within the collaborative document results 180.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device), or a propagation medium such as a carrier wave. Examples of a computer-readable medium include a semiconductor or solid state memory, magnetic tape, a removable computer diskette, a random access memory (RAM), a read-only memory (ROM), a rigid magnetic disk and an optical disk.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of generating a chronicle of search terms used in a network environment of a community, comprising:
receiving a term from a user in a current search;
matching the term in a search chronicle search, wherein the search chronicle is a database comprising a plurality of search terms, each search term associated with a search originator; and
providing the search chronicle search results to the user.

2. The method of claim 1, further comprising:
matching the term against a knowledge base in communication with the network environment; and
providing the knowledge base search results to the user.

3. The method of claim 1, further comprising:
adding the current search to the search chronicle.

4. The method of claim 1, further comprising:
determining if the user has chosen not to add the current search to the search chronicle; and
suppressing the current search from the search chronicle based on the determined user choice.

5. The method of claim 1, further comprising:
determining if the user is authorized to access details about the search originator; and
displaying the search originator details based on the determined authorization.

6. The method of claim 1, further comprising:
matching the term against a plurality of available collaborative documents.

7. The method of claim 6, further comprising:
displaying at least one matching collaborative document.

8. The method of claim 1, further comprising:
creating a collaborative document in association with at least one search term.

9. A system of generating a chronicle of search terms used in a network environment of a community, comprising:
means for receiving a term from a user in a current search;
means for matching the term in a search chronicle search, wherein the search chronicle is a database comprising a plurality of search terms, each search term associated with a search originator; and
means for providing the search chronicle search results to the user.

10. The system of claim 9, further comprising:
means for matching the term against a knowledge base in communication with the network environment; and
means for providing the knowledge base search results to the user.

11. The system of claim 9, further comprising:
means for determining if the user has chosen to add the current search to the search chronicle; and
means for adding the current search to the search chronicle based on the determined user choice.

12. The system of claim 9, further comprising:
means for determining if the user is authorized to access details about the search originator; and
means for displaying the search originator details based on the determined authorization.

13. The system of claim 9, further comprising:
means for matching the term against a plurality of available collaborative documents; and
means for displaying at least one matching collaborative document.

14. The system of claim 9, further comprising:
means for creating a collaborative document in association with at least one search term.

15. A computer program product, in a computer readable medium, for generating a chronicle of search terms used in a network environment of a community, comprising:
instructions for receiving a term from a user in a current search;
instructions for matching the term in a search chronicle search, wherein the search chronicle is a database comprising a plurality of search terms, each search term associated with a search originator; and
instructions for providing the search chronicle search results to the user.

16. The program of claim 15, further comprising:
instructions for matching the term against a knowledge base in communication with the network environment; and
instructions for providing the knowledge base search results to the user.

17. The program of claim 15, further comprising:
instructions for determining if the user has chosen to add the current search to the search chronicle; and
instructions for adding the current search to the search chronicle based on the determined user choice.

18. The program of claim 15, further comprising:
instructions for determining if the user is authorized to access details about the search originator; and
instructions for displaying the search originator details based on the determined authorization.

19. The program of claim 15, further comprising:
instructions for matching the term against a plurality of available collaborative documents; and
instructions for displaying at least one matching collaborative document.

20. The program of claim 15, further comprising:
instructions for creating a collaborative document in association with at least one search term.
